(19) United States
(12) Patent Application Publication
(10) Pub. No.: US 2006/0202946 A1
(43) Pub. Date: Sep. 14, 2006

(54) Channel data setting circuit and light emitting element drive circuit using the same

(75) Inventor: Norio Yoshimura, Atsugi-Shi (JP)

Correspondence Address: LADAS & PARRY, 26 WEST 61ST STREET, NEW YORK, NY, 10023, US

(73) Assignee: MITSUMI ELECTRIC CO., LTD.

(21) Appl. No.: 11/288,508

(22) Filed: Nov. 29, 2005

(30) Foreign Application Priority Data
Mar. 14, 2005 (JP) 2005-071546

(51) Int. Cl. G09G 3/36

(52) U.S. Cl. 345/102

(57) ABSTRACT

A channel data setting circuit and a light emitting element drive circuit using the channel data setting circuit are disclosed. A channel data setting circuit includes a clock unit that measures one of a low level period and a high level period of a pulse signal supplied from a single input terminal, and plural counter units in which different predetermined ranges corresponding to plural channels are set. Each of the counter units is adapted to enable a count when the period measured by the clock unit has a length within the corresponding predetermined range. The value of the count is used as a channel data item for the corresponding channel.

### BACKGROUND OF THE INVENTION

1. Field of the Invention

The present invention relates to a channel data setting circuit and a light emitting element drive circuit using the same, and particularly relates to a channel data setting circuit for setting plural channel data items and a light emitting element drive circuit using the same.

2. Description of the Related Art

In recent years, mobile phones have been using multiple light emitting diodes as backlight sources of their liquid crystal displays. A typical light element drive circuit for use in liquid crystal displays of such mobile phones comprises a shutdown terminal, and is configured to turn on all the light emitting diodes in response to a high level signal supplied from an upstream control circuit to the shutdown terminal, and turns off all the light emitting diodes in response to a low level signal.

Although a search for documents that disclose art relating to channel data setting circuits has been conducted, no such documents could be found.

The light emitting drive circuit of the type described above turns on or off all the light emitting diodes at the same time. That is, the light emitting drive circuit is not able to adjust luminance of the light emitting diodes individually, nor to turn on or off the light emitting diodes separately.

To realize the individual luminance adjustment of the multiple light emitting diodes, each of the light emitting diode requires a separate control input terminal for adjusting the luminance. However, it is not practical to increase the number of ports in the light emitting element drive circuit to provide for the increased number of control input terminals.

### SUMMARY OF THE INVENTION

According to one aspect of the present invention, there is provided a channel data setting circuit and a light emitting element drive circuit using the same, capable of setting data items for multiple channels according to a signal input from an input terminal, and capable of adjusting luminance of plural light emitting diodes individually.

In another aspect of the present invention, there is provided a channel data setting circuit comprising a clock unit that measures one of a low level period and a high level period of a pulse signal input from a single input terminal; and plural counter units in which different predetermined ranges corresponding to plural channels are set, each of the counter units being adapted to enable a count when the period measured by the clock unit has a length within the corresponding predetermined range; wherein a value of the count is used as a channel data item for the corresponding channel. The channel data setting circuit having such configuration can set plural channel data items in accordance with the signal input from the single input terminal.

In still another aspect of the present invention, there is provided a light emitting element drive circuit comprising a clock unit that measures one of a low level period or a high level period of a pulse signal input from a single input terminal; and plural counter units in which different predetermined ranges corresponding to plural channels are set, each of the counter unit being adapted to enable a count when the period measured by the clock unit has a length within the corresponding predetermined range; plural current control units each of the current control units being adapted to output a current in accordance with a value of the count supplied from the corresponding counter unit; and plural light emitting elements each of the light emitting elements being adapted to emit light at a luminance in accordance with the current supplied from the corresponding current control unit. The light emitting element drive circuit having such configuration is able to adjust the luminance of the light emitting elements individually.

### BRIEF DESCRIPTION OF THE DRAWINGS

FIG. 1 is a block diagram showing a channel data setting circuit according to an embodiment of the present invention;

FIG. 2 is a signal waveform diagram illustrating operations of a channel data setting circuit according to an embodiment of the present invention;

FIG. 3 is a block diagram showing a light emitting element drive circuit according to an embodiment of the present invention; and

FIG. 4 is a signal waveform diagram of a channel data setting circuit according to an embodiment of the present invention.

### DETAILED DESCRIPTION OF THE PREFERRED EMBODIMENT

The following provides exemplary embodiments of the present invention with reference to the accompanying drawings.

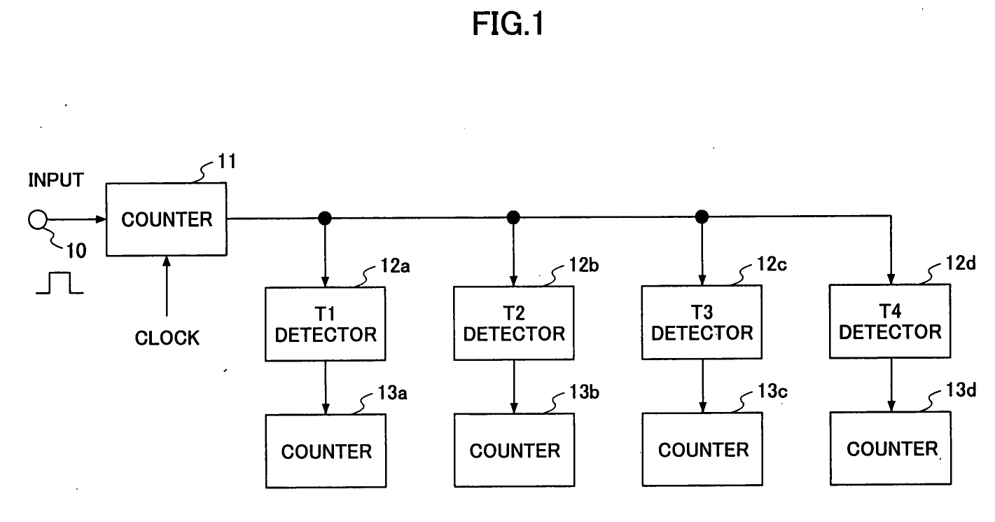

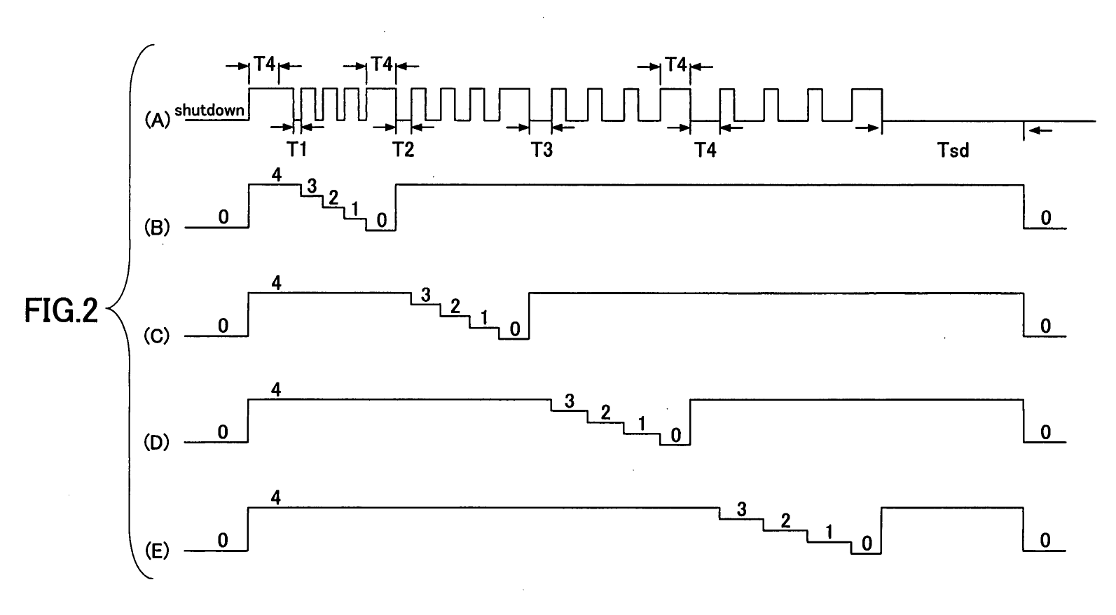

FIG. 1 is a block diagram showing a channel data setting circuit according to one embodiment of the present invention. With reference to FIG. 1, a channel data signal as shown in (A) of FIG. 2 is input into a counter 11 from an input terminal 10. A clock having a pulse speed sufficiently faster than the channel data setting signal is also input into the counter 11. The counter 11 counts the clock pulses to measure a low level period and a high level period, and outputs the measured data to T1 detector 12a- T4 detector 12d of four channels.

The T1 detector 12a generates a reset signal upon detecting a low level period of a length Tsd (e.g. 2 msec or more), generates a countdown signal upon detecting a low level period of a length T1 (e.g. within a range of 1-125 μsec), and generates a preset signal upon detecting a high level period of a length T4 (e.g. within a range of 750-875 μsec) or greater. The signals generated by the T1 detector 12a are supplied to a counter 13a.

The T2 detector 12b generates a reset signal upon detecting the low level period of the length Tsd (e.g. 2 msec or more), generates a countdown signal upon detecting a low level period of the length T2 (e.g. within a range of 250-375 μsec), and generates a preset signal upon detecting the high level period of the length T4 or greater. The signals generated by the T2 detector 12b are supplied to a counter 13b.

The T3 detector 12c generates a reset signal upon detecting the low level period of the length Tsd, generates a countdown signal upon detecting a low level period of the length T3 (e.g. within a range of 500-625 μsec), and generates a preset signal upon detecting the high level period of the length T4 or greater. The signals generated by the T3 detector 12c are supplied to a counter 13c.

The T4 detector 12d generates a reset signal upon detecting the low level period of the length Tsd, generates a countdown signal upon detecting a low level period of the length T4 (e.g. within a range of 750-875 μsec), and generates a preset signal upon detecting the high level period of the length T4 or greater. The signals generated by the T4 detector 12d are supplied to a counter 13d.

The counters 13a- 13d, which are 2-bit counters, reset the count to “0” upon receiving the reset signal, preset the count to “4” upon receiving the preset signal, and decrement the count by “1” upon receiving the countdown signal.

Accordingly, in response to the channel data setting signal as shown in (A) of FIG. 2, the count of the counter 13a is preset to “4” upon detection of a high level period of the length T4 or greater, sequentially decremented every time a low level period of the length T1 is detected, and then preset to “4” upon detection of a high level period of the length T4 as shown in (B) of FIG. 2.

Referring to (C) of FIG. 2, the count of the counter 13b is preset to “4” upon detection of the high level period of the length T4 or greater, sequentially decremented every time a low level period of the length T2 is detected, and then preset to “4” upon detection of the high level period of the length T4.

Similarly, as shown in (D) of FIG. 2, the count of the counter 13c is preset to “4” upon detection of the high level period of the length T4 or greater, sequentially decremented every time a low level period of the length T3 is detected, and then preset to “4” upon detection of the high level period of the length T4. Referring to (E) of FIG. 2, the count of the counter 13d is preset to “4” upon detection of the high level period of the length T4 or greater, sequentially decremented every time a low level period of the length T4 is detected, and then preset to “4” upon detection of the high level period of the length T4.

In this way, data items corresponding to four channels can be set in the counters 13a-13d, respectively, in accordance with the signal input from the single input terminal 10.

In an alternative embodiment, the counters 13a- 13d may have the count unchanged while the high level period does not exceed Tsd, and preset the count when the high level period reaches Tsd. Further, the counters 13a- 13d may increment the count instead of decrementing the count.

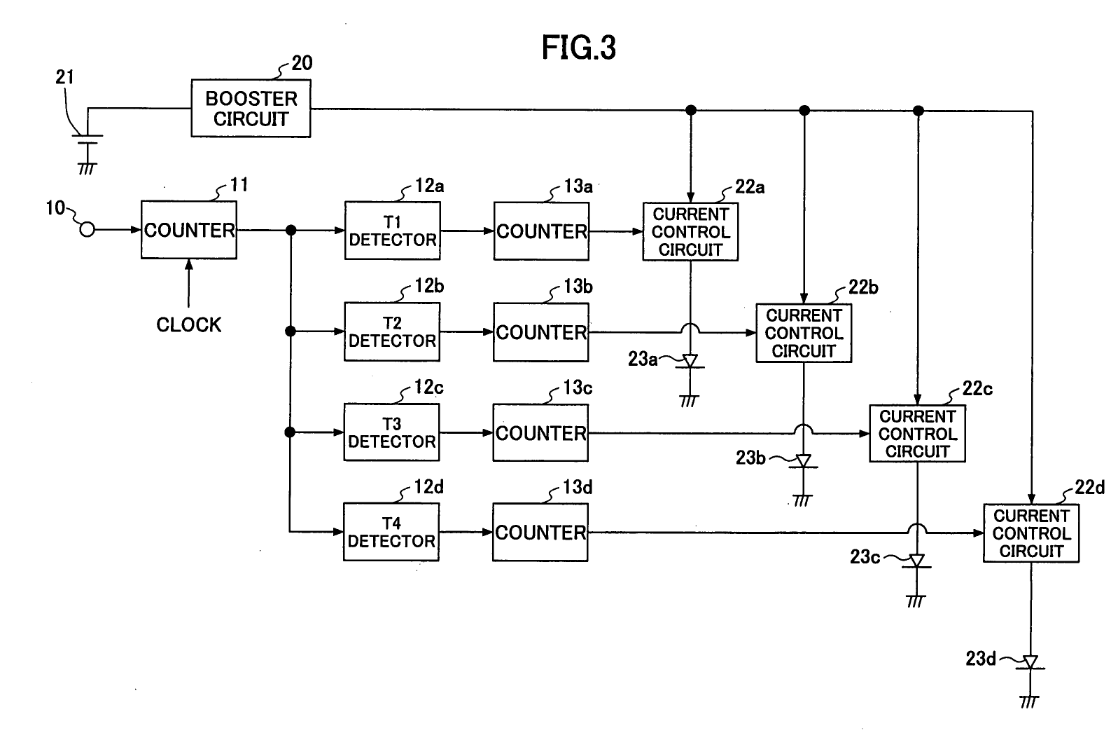

FIG. 3 is a block diagram showing a light emitting element drive circuit according to one embodiment of the present invention. The light emitting element drive circuit uses the channel data setting circuit of FIG. 1. In FIG. 3, components identical to those in FIG. 1 bear the same reference numerals.

With reference to FIG. 3, a boosting circuit 20 increases a voltage supplied from a battery 21 to about 5V, and supplies the increased voltage to each of current control circuits 22a- 22d. The current control circuits 22a- 22d determine current values to be applied to corresponding white light emitting diodes 23a-23d in accordance with the counts supplied from the corresponding counters 13a- 13d. The white light emitting diodes 23a- 23d emit light with luminances that are generally in proportion to the applied current values.

A channel data signal as shown in (A) of FIG. 2 is input to a counter 11 from an input terminal 10. A clock having a pulse speed sufficiently faster than the channel data setting signal is also input to the counter 11. The counter 11 counts the clock pulses to measure a low level period and a high level period, and outputs the measured data to T1 detector 12a- T4 detector 12d of four channels.

The T1 detector 12a generates a reset signal upon detecting a low level period of the length Tsd (e.g. 2 msec or more), generates a countdown signal upon detecting a low level period of the length T1 (e.g. within a range of 1-125 μsec), and generates a preset signal upon detecting a high level period of the length T4 (e.g. within a range of 750-875 μsec) or greater. The signals generated by the T1 detector 12a are supplied to a counter 13a.

The T2 detector 12b generates a reset signal upon detecting the low level period of the length Tsd (e.g. 2 msec or more), generates a countdown signal upon detecting a low level period of the length T2 (e.g. within a range of 250-375 μsec), and generates a preset signal upon detecting the high level period of the length T4 or greater. The signals generated by the T2 detector 12b are supplied to a counter 13b.

The T3 detector 12c generates a reset signal upon detecting the low level period of the length Tsd (e.g. 2 msec or more), generates a countdown signal upon detecting a low level period of the length T3 (e.g. within a range of 500-625 μsec), and generates a preset signal upon detecting the high level period of the length T4 or greater. The signals generated by the T3 detector 12c are supplied to a counter 13c.

The T4 detector 12d generates a reset signal upon detecting the low level period of the length Tsd (e.g. 2 msec or more), generates a countdown signal upon detecting a low level period of the length T4 (e.g. within a range of 750-875 μsec), and generates a preset signal upon detecting the high level period of the length T4 or greater. The signals generated by the T4 detector 12d are supplied to a counter 13d.

The counters 13a- 13d, which are 2-bit ring counters, reset the count to “0” upon receiving the reset signal, preset the count to “4” upon receiving the preset signal, and decrement the count by “1” upon receiving the countdown signal.

Accordingly, in response to the channel data setting signal as shown in (A) of FIG. 2, the count the counter 13a is preset to “4” upon detection of a high level period of the length T4 or greater, sequentially decremented every time a low level period of the length T1 is detected, and then preset to “4” upon detection of a high level period of the length T4 as shown in (B) of FIG. 2.

Referring to (C) of FIG. 2, the count of the counter 13b is preset to “4” upon detection of the high level period of the length T4 or greater, sequentially decremented every time a low level period of the length T2 is detected, and then preset to “4” upon detection of the high level period of the length T4.

Similarly, as shown in (D) of FIG. 2, the count of the counter 13c is preset to “4” upon detection of the high level period of the length T4 or greater, sequentially decremented every time a low level period of the length T3 is detected, and then preset to “4” upon detection of the high level period of the length T4. Referring to (E) of FIG. 2, the count of the counter 13d is preset to “4” upon detection of the high level period of the length T4 or greater, sequentially decremented every time a low level period of the length T4 is detected, and then preset to “4” upon detection of the high level period of the length T4.

The counts of the counter 13a- 13d are supplied to the corresponding current control circuits 22a- 22d. The current control circuit 22a applies current to make the luminance of the white light emitting diode 23a 100% when the count is “4”, applies current to make the luminance of the white light emitting diode 23a 75% when the count is “3”, applies current to make the luminance of the white light emitting diode 23a 50% when the count is “2”, applies current to make the luminance of the white light emitting diode 23a 25% when the count is “1”, and applies no current when the count is “0”. The current control circuits 22b- 22d operate in the same manner as the current control circuit 22a.

In this way, data items corresponding to four channels can be set in the counters 13a- 13d, respectively, in accordance with the signal input through the single input terminal 10. The luminances of the white light emitting diodes 23a- 23d are thus set and adjusted individually.

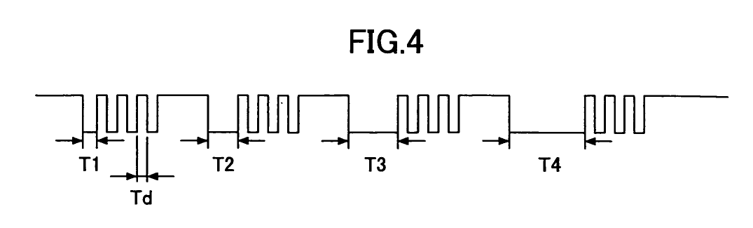

In an alternative embodiment, a channel data signal as shown in FIG. 4 may be supplied to the input terminal 10. In this case, the T1 detector 12a generates a reset signal upon detecting a low level period of the length Tsd (e.g. 2 msec or more), generates a countdown signal every time the T1 detector 12a detects a low level period of the length Td (e.g. within a range of 1-50 μsec) after detecting a low level period of the length T1 (e.g. within a range of 1-125 μsec), and generates a preset signal upon detecting a high level period of the length Tsd or greater. The signals generated by the T1 detector 12a are supplied to the counter 13a.

The T2 detector 12b generates a reset signal upon detecting a low level period of the length Tsd, generates a countdown signal every time the T2 detector 12b detects a low level period of a length Td after detecting a low level period of the length T2 (e.g. within a range of 250-375 μsec), and generates a preset signal upon detecting a high level period of the length Tsd or greater. The signals generated by the T2 detector 12b are supplied to the counter 13b.

The T3 detector 12c generates a reset signal upon detecting a low level period of the length Tsd, generates a countdown signal every time the T3 detector 12c detects a low level period of the length Td after detecting a low level period of the length T3 (e.g. within a range of 500-625 μsec), and generates a preset signal upon detecting a high level period of the length Tsd or greater. The signals generated by the T3 detector 12c are supplied to the counter 13c.

The T4 detector 12d generates a reset signal upon detecting a low level period of the length Tsd, generates a countdown signal every time the T4 detector 12d detects a low level period of the length Td after detecting a low level period of the length T4 (e.g. within a range of 750-875 μsec), and generates a preset signal upon detecting a high level period of the length Tsd or greater. The signals generated by the T4 detector 12d are supplied to the counter 13d.

With this configuration, the number of low level periods T1, T2, T3, and T4 is reduced by a partial replacement by the low level period Td, which is shorter than each of the low level periods T1, T2, T3, and T4. It is therefore possible to reduce the time required for setting the multiple channel data items.

Although the above described embodiments focus on the operations for setting the data items in four channels, the number of channels is not limited to four. Further, light emitting elements other than the white light emitting diodes may be used.

The above embodiments employ the counter 11 as a component corresponding to a clock unit in the appended claims, the counters 13a- 13d as components corresponding to counter units, the T1 detector 12a- T4 detector 12d as components corresponding to period detector units, and the current control circuits 22a-22d as components corresponding to current control units.

The present application is based on Japanese Priority Application No. 2005-071546 filed on Mar. 14, 2005, with the Japanese Patent Office, the entire contents of which are hereby incorporated by reference.

What is claimed is:

1. A channel data setting circuit comprising:
a clock unit that measures one of a low level period and a high level period of a pulse signal input from a single input terminal; and
a plurality of counter units in which different predetermined ranges corresponding to a plurality of channels are set, each of the counter units being adapted to enable a count when the period measured by the clock unit has a length within the corresponding predetermined range;
wherein a value of the count is used as a channel data item for the corresponding channel.

2. The channel data setting circuit as claimed in claim 1, further comprising:
a plurality of period detector units corresponding to the counter units and in which the predetermined ranges are set, each of the period detector units being adapted to generate a count signal when the period measured by the clock unit has a length within the corresponding predetermined range;
wherein the value of the count enabled by the counter unit changes in response to the count signal supplied from the corresponding period detector unit.

3. A light emitting element drive circuit comprising:
a clock unit that measures one of a low level period and a high level period of a pulse signal input from a single input terminal; and
a plurality of counter units in which different predetermined ranges corresponding to a plurality of channels are set, each of the counter units being adapted to enable a count when the period measured by the clock unit has a length within the corresponding predetermined range;
a plurality of current control units each of the current control units being adapted to output a current in accordance with a value of the count supplied from the corresponding counter unit; and
a plurality of light emitting elements each of the light emitting elements being adapted to emit light at a luminance in accordance with the current supplied from the corresponding current control unit.

4. The light emitting element drive circuit as claimed in claim 3, further comprising:
a plurality of period detectors corresponding to the counter units and in which said period detectors predetermined ranges are set, each said period detector being adapted to generate a count signal when the period measured by the clock unit has a length within the corresponding predetermined range;
wherein the value of the count enabled by the counter unit changes in response to the count signal supplied from the corresponding period detector unit.
